(19) United States
(12) Patent Application Publication
(10) Pub. No.: US 2004/0129651 A1
(43) Pub. Date: Jul. 8, 2004

(54) Metal fiber filter element

(76) Inventors: Guy Vanhoutte, Kortrijk (BE); Yves Struyve, Waregem (BE); Thierry Quequin, Kortrijk (BE)

Correspondence Address: FOLEY AND LARDNER, SUITE 500, 3000 K STREET NW, WASHINGTON, DC, 20007, US

(21) Appl. No.: 10/474,425

(22) PCT Filed: Mar. 28, 2002
(86) PCT No.: PCT/EP02/03713

(30) Foreign Application Priority Data
Apr. 11, 2001 (EP) 01201328.0

(51) Int. Cl. B01D 33/44

(52) U.S. Cl. 210/798

(57) ABSTRACT

A metal fiber filter element comprises a metal fiber fleece and a reinforcing structure being a metal sheet. This metal sheet has open areas and is sintered to the metal fiber fleece which covens the open areas.

### FIELD OF THE INVENTION

The present invention relates to a metal fiber filter element and the use of metal fiber filter elements in filter units applying reverse pulses to clean the filter. The invention relates also to tubular metal fiber filter elements. Further, the present invention relates to a method to provide a metal fiber filter element, possibly tubular.

### BACKGROUND OF THE INVENTION

Metal fiber filter elements are well known in the art, and used for several filtration applications, such as hot gas or liquid filtration, and polymer filtration.

During filtration, retained particles are kept in or on the surface of the metal fiber filter element. Periodically, the retained particles are to be removed from or out of the filter. This may be done in situ by reverse pulses. During a very short time period (e.g. 0.1 to 0.5 seconds) and at a relatively high pressure, the particles are pulsed, e.g. blown or pushed backwards and removed out of or from the metal fiber filter element. However, these severe pressure pulses may damage the metal fiber filter element. Several reinforcing systems based on metal wire mesh have been tried to make the metal fiber filter element more resistant to these reverse pulses. However to benefit most from the reinforcing structure, this wire structure is preferably used when located at the side of the metal fiber filter element, where the liquid or gas, which is to be filtered, enters into the metal fiber filter element. This side will hereafter be referred to as “flow in side”. The reverse pulses, so to say, expand the metal fiber fleece in a direction towards the flow in side, and the reinforcing structure is to absorb the energy, provided by the pulses and causing this expansion.

However, flowing in particles may be stuck to the reinforcing structure and, during reverse pulses, they tend to stick to the reinforcing structure. Even more, between two or more wires, particles may cohere and form so called bridging effect, causing zones, consisting of particles, which extend from one wire to another. These bridges may not be pulsed away from the metal fiber fleece. To avoid such coherence of particles to the metal fiber fleece, a surface as flat and as smooth as possible is preferred.

If a metal fiber fleece is not supported, the repetitive reverse pulsing may cause fatigue failures of the metal fiber fleece.

When a wire reinforcing structure is applied on the other side of the metal fiber filter element, the connection between metal fiber fleece and wire mesh may be disrupted, or even broken. The reinforcing wire structure looses its function during reverse pulsing and the metal fiber fleece has to support the pressure pulses on its own, causing fatigue ruptures.

Further, when a tubular metal fiber filter element is required, the presently known metal fiber fleece has a disadvantage that it is difficult, if not impossible to weld the metal fiber fleece, which provides difficulties in transforming e.g. a flat metal fiber filter element into a tubular shape.

### SUMMARY OF THE INVENTION

According to the present invention, a metal fiber filter element is provided, comprising a metal fiber fleece and a reinforcing structure. The reinforcing structure comprising a metal sheet, having open areas, which are provided by holes and/or apertures.

A metal sheet is to be understood as an object out of metal or a metal alloy, having an essentially flat surface and being essentially plane.

This metal sheet, having open areas, which are provided as holes and/or apertures, will hereafter be referred to as “perforated metal sheet”. “Perforated” however is not to be understood restrictively. The open areas in the perforated metal sheet may be provided by perforation, but also by e.g. laser cutting, drilling, die cutting, punching or any other known technique to provide open area to a metal sheet. Possibly, although less preferred, stretch metal sheets may be used.

An “open area” of the perforated metal sheet is to be understood as a zone of the perforated metal sheet, where the metal has been removed or an aperture or perforation has been provided. The remaining area of the perforated metal sheet, where the metal has not been removed, is referred to hereafter as “metal area”.

According to the present invention, the metal fiber fleece and the reinforcing structure are sintered to each other, in such a way that the metal fiber fleece covers all open areas of the perforated metal sheet completely. The metal fiber fleece is sintered to the metal area of the perforated metal sheet over the total surface of the metal fiber fleece. Preferably, but not necessarily, the perforated metal sheet may extend beyond the metal fiber fleece. Since the perforated metal sheet has an essentially flat surface, which contacts the metal fiber fleece at the metal areas, the sintered contact between metal fiber fleece and perforated metal sheet is obtained over essentially the whole surface of the metal area.

Preferably, the smallest distance between the edge of an open area, closest to the edge of the metal fiber fleece is more than 10 mm or even more than 20 mm. In other words, the metal fiber fleece and the metal area of the perforated metal sheet have a common zone with a width of at least 10 mm at the edge of the metal fiber fleece. These zones will hereafter be referred to as ‘common zones’. This common zone is to be foreseen in order to avoid non filtered liquid or gas by-passing the filter at the edge of the metal fiber fleece. Alternatively, the edge of the metal fiber fleece may be subjected to a welding operation or a compressing operation, to close the pores of the metal fiber fleece at its edge, in order to avoid by-pass of gas or liquid via the edge of the metal fiber fleece.

A metal fiber fleece may be sintered first to obtain a sintered metal fiber fleece. This sintered metal fiber fleece is than sintered to the perforated metal sheet as subject of the invention. Alternatively, the metal fiber fleece and perforated metal sheet are sintered to each other during one sintering step.

The dimensions of the open areas are chosen in such a way that the minimum distance of each point of an open area and the edge of the open area is less than 65 mm. Preferably this distance is less than 50 mm, or even less than 25 mm, such as 20 mm, 10 mm or even 3 mm. This distance will hereafter also be referred to as “smallest distance” or “critical distance”. The shapes of the open areas of the perforated metal sheet preferably are circular, square, rectangular, trapezoid or parallelogram-like.

When those characteristics are taken, it was found that the sinter-bonding between metal fiber fleece and perforated metal sheet was improved.

According to the present invention, the total open area of the perforated metal sheet is preferably more than 25% compared to the surface of the metal fiber fleece, which covers the open areas according to the present invention. Preferably, the total open area is more than 50%, most preferably more than 70% or even more than 85%. To maintain a reinforcing effect however, the total open area must preferably not be more than 90%.

Preferably, the dimensions of the open areas is chosen in such a way that the for at least one point of the open area, its minimum or smallest distance to the edge of the open area is larger than 0.5 mm or even larger than 1 mm, such as larger than 2 mm or even larger than 3 mm.

With “total open area” of the perforated metal sheet is meant the sum of the surfaces of all open areas present at the surface of the perforated metal sheet, and which are, according to the present invention are covered by the metal fiber fleece.

A filtration system, of which the metal fiber filter element is part of, typically has a system pressure. This is the pressure used to supply the liquid or gas to the metal fiber filter element. To remove the retained particles from the filtration surface by reverse pulsing (hereafter also referred to as “reverse flow cdeaning”), a reverse pulse pressure of at least this system pressure, but usually much higher, is to be used. Due to the variety of system pressures, the critical distance and the total open area of the perforated metal sheet compared to the surface of the metal fiber fleece depend on the reverse pulse pressure level to be resisted by the metal fiber filter element. In cases the reinforcing layer is located at the flow-out side of the filter medium, the metal fiber fleece is not supported at the flow-in side during reverse flow cleaning.

However, due to the sinter-bond between the reinforcing layer located at the flow-out side of the filter medium and the metal fiber fleece, the metal fiber fleece is not disconnected from the perforated metal sheet. The sinter-bond is sufficiently strong so that the energy provided by reverse flow cleaning such as high pressure liquid cleaning can be absorbed without bending or deforming the metal fiber fleece.

Any metal sheet may be used to provide a perforated metal sheet. Preferably, a metal sheet out of Ni or stainless steel is used, such as AISI 316L or Inconel®. Preferably, the perforated metal sheet and the metal fiber fleece are provided out of the same or a similar metal alloy. The thickness of the perforated metal sheet preferably is in the range of 0.5 mm to 2 mm.

Any type of metal or metal alloy may be used to provide the metal fibers of the metal fiber fleece. Preferably, Ni-fibers or stainless steel fibers are used, e.g. stainless steel fibers from AISI 300- or AISI 400-serie alloys such as AISI 316L or AISI347, or alloys comprising Fe, Al and Cr, stainless steel comprising chromium, aluminum and/or nickel and 0.05 to 0.3% by weight of yttrium, cerium, lanthanum, hafnium or titanium are used, such as Fecralloy®.

The equivalent fiber diameter preferably is between 0.5 μm and 100 μm, e.g. between 2 and 25 μm. With equivalent diameter is meant, the diameter of an imaginary circle, said circle having the same surface of the surface of a radial or cross section of the metal fiber.

The metal fibers may be obtainable by bundle drawing or by shaving techniques (e.g. as described in U.S. Pat. No. 4,930,199), or by any other process as known in the art.

The metal fiber fleece used to provide a metal fiber filter element as subject of the invention may comprise only one layer of metal fibers, or may be a stack of different fiber layers, each fiber layer comprising metal fibers with a specific equivalent fiber diameter, fiber density and weight of the layer. This weight of each layer is expressed in g/m², and will hereafter be referred to as “specific layerweight”.

Possibly, a metal wire woven or knitted mesh may be added to the metal fiber fleece. Preferably, the metal wire mesh is located between two layers of metal fibers. Less preferred, although possible, a metal wire mesh is added at the opposite side of the metal fiber fleece, as compared to the side to the metal fiber fleece to which the perforated metal sheet is sintered.

Alternatively, another metal fiber filter element as subject of the invention is provided sintering two perforated metal sheets to a metal fiber fleece. The metal fiber fleece is than positioned between the two perforated metal sheets, one perforated metal sheet on each side of the metal fiber fleece. Alternatively, another metal fiber filter element as subject of the invention is provided sintering a perforated metal sheet between two layers of metal fiber fleece.

According to the present invention, it was found that, when a metal fiber fleece is sintered to a perforated metal sheet having an open area percentage, critical distances and dimensions as described above, the mechanical properties of a metal fiber filter element as subject of the invention is drastically improved, compared to non-reinforced sintered metal fiber fleeces or metal fiber fleeces, reinforced with a wire mesh. It was found that when open areas with dimensions larger than above-mentioned were used, the metal fiber fleece and the perforated metal sheet may come loose during the cleaning operation of the filter, especially when high pressure back-flushes are used to clean the filter, especially when using the metal fiber fleece at the inflow side of the filter.

A metal fiber fleece being sintered to a perforated metal sheet as subject of the invention, may be used as a flat metal fiber filter element, or may further be transformed into a tubular metal fiber filter element. Such tubular metal fiber filter element may be obtained by bending a flat metal fiber filter element into the desired tubular shape, and welding the edges of the flat metal fiber filter element to each other, which have to be closed to obtain a tubular metal fiber filter element. This welding can be done by resistance welding, overlapping the ends of the flat metal fiber filter element and welding the overlap to each other. These ends may consist of metal area of the perforated metal sheet, extending beyond the metal fiber fleece, or may consist of the common zone of the metal fiber fleece and perforated metal sheet. Possibly, TIG-welding, brazing, soldering or gluing can be applied as well.

Possibly, the metal fiber filter element is connected to other parts of a filter system, of which the metal fiber filter element is part of, using the zones of the perforated metal sheet, extending from the metal fiber fleece, or the common zones.

A metal fiber filter element as subject of the invention has several advantages to known mesh-reinforced or non-reinforced metal fiber filters.

During transformation of the metal fiber filter element into its final form, e.g. tubular, the mechanical forces used to bend, weld, or shape the metal fiber filter element are resisted much better. This is due to the fact that a metal fiber filter element as subject of the invention has an improved stiffness. The metal fiber filter element may further be welded in an identical way as if it was a metal sheet.

Usually, metal fiber filter elements are used to filter either gases or liquids. The metal fiber filter elements are subjected periodically to reverse pulses, to clean the metal fiber filter element in situ. Since these reverse pulses are executed with a higher pressure as compared to the system pressure, partially used to filter the gasses or liquids, the presently known reinforced metal fiber filter element are used with the reinforcing structure, e.g. wire meshes, being located at the flow in side.

Since the reverse pulses are executed with pressures, being applied on from the flow out side to the flow inside, the reinforcing structures of the presently known metal fiber filter element are preferably situated at the flow in side of the metal fiber filter element. A metal fiber filter element as subject of the invention however has a very strong bond between reinforcing structure and metal fiber fleece (due to the flat surface of the perforated metal sheet), that the reinforcing structure may be present at the flow out side of the metal fiber filter element. During reverse pulses, the metal fiber fleece is not blown or pushed away from the reinforcing structure, but sticks to the reinforcing structure due to the larger area over which both parts are sintered to each other, as compared to e.g. a reinforcing mesh, where the sintering essentially is obtained by line-contacts between the individual wires and the metal fiber fleece. This provides the advantage that the retained particles, which are retained by the metal fiber filter element, cannot stick to the relatively coarse surface of the reinforcing structure as was known for filter elements as were known in the art. Reverse pulses result in much more efficient and complete cleaning of the metal fiber filter element.

Another advantage of a metal fiber filter element as subject of the invention is the increased stiffness of the metal fiber filter element, essentially due to the stiffness of the metal sheet.

Larger filter surfaces may be mounted in horizontal or vertical direction, without the need for extra support as compared to the presently known metal fiber filter surfaces. A metal fiber filter element as subject of the invention is so-to-say self-supporting.

The metal fiber filter element as subject of the invention may be used to provide filter plates, which comprises a pair of metal fiber filter element as subject of the invention. Both metal fiber filter element are positioned with their planes parallel to each other. The outer edges of the metal fiber filter element are sealed using appropriate sealing means, in order to obtain a filter plate, having two surfaces being metal fiber filter element as subject of the invention. Possibly, but not necessarily, a spacer layer, e.g. a mesh, foam or stretch metal (expanded metal sheet) is positioned between the two metal fiber filter element. The metal fiber filter element may be positioned in such a way that the metal fiber fleece is pointing inwards or outwards of the filter plate.

Such filter plate may be used during filtering operations being positioned horizontally or vertically. The stiffness of the plate is sufficient to support its weight. Preferably, liquids or gasses are forced (e.g. using an over-pressure) to flow from the outer side of the filter plate, via the metal fiber filter element, possibly through the spacer layer towards a liquid or gas evacuation duct. It is clear for a person skilled in the art, that the edges of the filter plate are to be sealed in order to prevent bypasses of unfiltered liquids or gasses.

Alternatively, but less preferred, the liquids or gasses may flow in opposite direction through the filter plate.

Advantageously, such filter plates as subject of the invention are used for filtering food liquids such as wine, beer, juice or oil such as olive oil.

Further according to the present invention, a method to provide a metal fiber filter element as subject of the invention is provided.

A metal fiber fleece is provided according to a known technique as known in the art. The metal fiber fleece, possibly but not necessarily sintered, is then positioned on a perforated metal sheet. Open areas were provided to a metal sheet, using a known technique as known in the art. According to the present invention, the total open area of the perforated metal sheet is more than 25% compared to the surface of the metal fiber fleece, which covers the open areas according to the present invention. Each open area of the perforated metal sheet preferably has a dimension, which provides a distance between each point of the open area and the edge of this open area of less than 65 mm. The shapes of the open areas of the perforated metal sheet preferably are circular, square, rectangular, trapezoid or parallelogram-like.

According to a method to provide a metal fiber filter element as subject of the invention, the metal fiber fleece, either already sintered or not, is sintered to the perforated metal sheet, so providing a flat metal fiber filter element as subject of the invention.

In order to avoid by-pass of gas or liquid via the edge of the metal fiber fleece, being sintered to the metal area of the perforated metal sheet, a common zone having a width of preferably more than 10 mm may be provided. Alternatively, the edge is to be welded e.g. by resistance welding to the metal area over the total edge of the metal fiber fleece, or the edge of the metal fiber fleece is to be compressed using extensive pressure, in order to seal the edge of the metal fiber fleece and prevent by-passes of non filtered liquid or gas via the edge.

This flat metal fiber filter element may then be transformed into a tubular metal fiber filter element by bending two edges of a flat metal fiber filter element, preferably parallel to each other, towards each other, around an imaginary axis. Both edges are connected to each other, preferably by TIG- or resistance welding. A tubular shape is given in this way to the metal fiber filter element. Further, an end cap may be provided to one of the ends of the tubular shape. This end cap is connected to this end preferably by a TIG- or resistance welding operation. Alternatively, and according to the filtration system of the filter system of which the metal fiber filter element is to be part of, no end caps may be provided, but the metal fiber filter element may be connected, e.g. welded directly to the module of the filter system. Since the welds are provided at a metal area, extending beyond the metal fiber fleece, or at the common zone, no special welding operations are to be used in order to weld the metal fiber filter element, which is an advantage as compared to the welding of metal fiber fleece as such.

A filter medium as subject of the invention may be used for several uses, such as filtration of cooling liquids of metal milling apparatuses, waste waters, liquids containing vulnerable or noble or precious metals or particles, or liquids such as food liquids and beverages such as wine, beer, juice or olive oil.

It is understood that the dimensions of the filter medium and the filtering apparatuses will be chosen in order to meet the requirements of the different filter applications.

### BRIEF DESCRIPTION OF THE DRAWINGS

The invention will now be described into more detail with reference to the accompanying drawings wherein

FIG. 1 schematically shows a metal fiber filter element as subject of the invention.

FIG. 2 schematically shows a section of a metal fiber filter element as in FIG. 1.

FIG. 3 schematically shows a perforated metal sheet with circular open areas to provide a metal fiber filter element as subject of the invention.

FIG. 4a and FIG. 4b schematically show a perforated metal sheet with rectangular or diamond-like open areas to provide a metal fiber filter element as subject of the invention.

FIG. 5a and FIG. 5b schematically show a perforated metal sheet with parallelogram-like open areas to provide a metal fiber filter element as subject of the invention.

FIG. 6a, FIG. 6b, FIG. 6c and FIG. 7 schematically show a metal fiber filter element to provide a tubular metal fiber filter element as subject of the invention

FIG. 8 schematically shows an alternative metal fiber filter element to provide a tubular metal fiber filter element as subject of the invention.

FIGS. 9a and 9b schematically show a planar section of filter plate as subject of the invention.

FIG. 10 schematically shows a front view of a filter plate as subject of the invention.

### DESCRIPTION OF THE PREFERRED EMBODIMENTS OF THE INVENTION

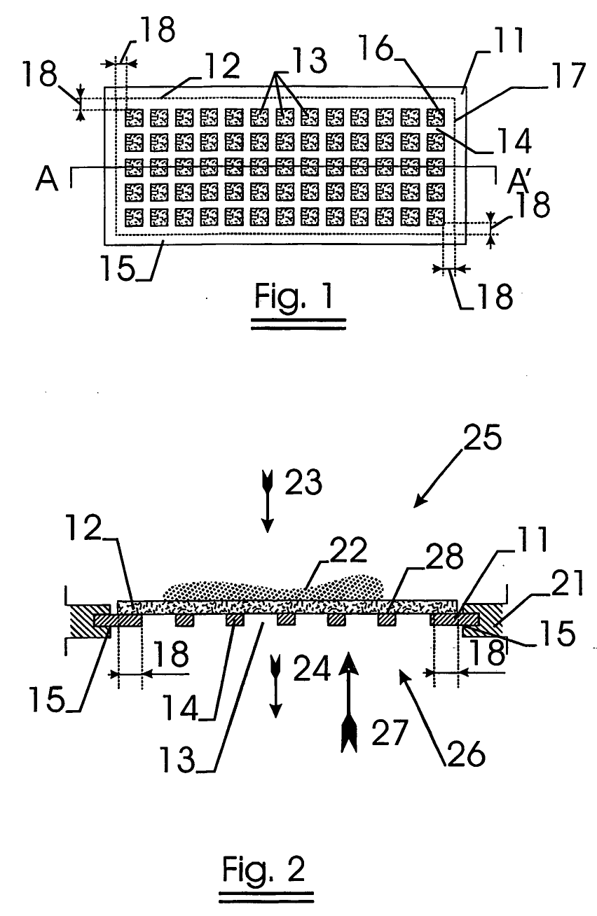

A flat metal fiber filter element as subject of the invention is shown schematically in FIG. 1. The metal fiber filter element comprises a perforated metal sheet 11, which functions as reinforcing structure for a metal fiber fleece 12 (drawn in dashed line where it is covered by the perforated metal sheet). The perforated metal sheet 11 has several open areas 13, and a metal area 14. Perforated metal sheet and metal fiber fleece are sintered to each other over the total surface of the metal area, which covers the metal fiber fleece. The perforated metal sheet 11 has a part 15 of its metal area, which extends beyond the metal fiber fleece 12. Further, the edge 16 of an open area closest to the edge 17 of the metal fiber fleece defines a common zone with a width 18 of at least 10 mm. Alternatively, the width of this common zone may be smaller, however, preferably the edge of the metal fiber fleece is sealed by closing the pores of the metal fiber fleece at its edge by welding, e.g. resistance welding. Alternatively, the edge of the metal fiber fleece is sealed by compression of the edge, substantially closing the pores of the metal fiber fleece in the compressed zone. As an example, open areas 13 having a square shape, the edges of the squares being 40 mm may be provided. Between each adjacent sides of adjacent square open area 13, a metal area 14 having a width of 3 mm may be provided. The total open area is thus more than 85% of the total surface of the metal fiber fleece.

FIG. 2 shows a section of the metal fiber filter element of FIG. 1, after it has been connected to another parts of a filter unit, e.g. a filter chamber 21. The metal fiber filter element is connected to the filter unit at the part 15 of the perforated metal sheet 11, which extends beyond the metal fiber fleece 12. Liquid or gas, loaded with particles 22 flows towards the metal fiber filter element 11 in the direction as indicated with arrow 23. Filtered liquid or gas flows away from the metal fiber filter element as indicated with arrow 24. The side 25 of the metal fiber filter element is called flow in side, the side 26 of the metal fiber filter element is called flow out side. When reverse pulses are applied to remove the retained particles, which are trapped on the flow in side of the metal fiber filter element, a pressure pulse is given in direction as indicated with arrow 27. Due to the sintered connection between the perforated metal sheet and the metal fiber fleece over the whole and essentially flat surface 28 of the metal area 14, the metal fiber fleece 12 is not disconnected from the perforated metal sheet 11. The metal fiber fleece however is not supported by a reinforcing structure at its flow in side. Particles 24 being retained at the flow in side may be removed uniformly by reverse pulses and are not hindered or stuck by a reinforcing structure being present at the flow in side.

To provide a preferred embodiment of the present invention, preferably a metal fiber fleece is provided using AISI 316L type fibers being provided in three layers. A first layer, of the metal fiber fleece, being present at the flow in side of the metal fiber fleece comprises a layer of 2 μm equivalent diameter fiber, with a specific layerweight of 450 g/m². A second layer, being present beyond this first layer, comprises 4 μm equivalent diameter fibers. This second layer has a specific layerweight of 300 g/m². A third layer of metal fibers, being present beyond the second layer and facing the flow out side of the metal fiber fleece, consists of a layer with a specific layerweight of 600 g/m² of fibers with equivalent diameter of 6.5 μm. These three layers are sintered to each other and to a perforated metal sheet out of AISI 316L stainless steel of 1 mm thickness, having square perforations with width and height 10 mm, and metal areas between the open areas of 2 mm. A metal fiber filter element with absolute filter rating of 2 μm may be obtained.

This metal fiber fleece is preferably sintered first, without presence of a perforated metal sheet, before it is sintered to the metal sheet. This sintered metal fiber fleece may then be compressed to obtain a required filter efficiency. This sintered metal fiber fleece is than sintered to a perforated metal plate.

An alternative embodiment comprises an identical perforated metal sheet as described above, but preferably has a thickness in the range of 0.25 to 0.5 mm. at both sides of the perforated metal sheet, a metal fiber fleece is provided, having e.g. an identical stack of layers as described above.

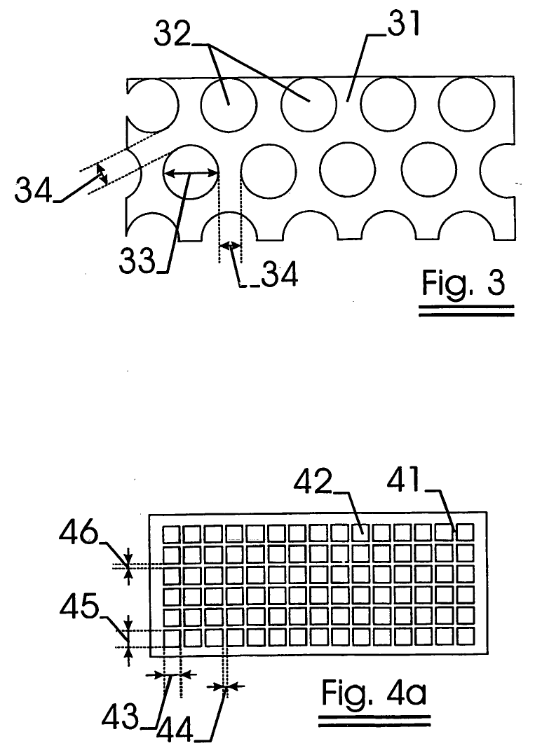

Many different dimensions of open areas may be chosen to obtain a metal fiber filter element as subject of the invention. When circular open areas are applied, a perforated metal sheet may be provided as shown in FIG. 3.

A perforated metal sheet comprises a metal area 31. Repetitively, circular open areas 32 are present in the surface of the perforated metal sheet. Each open area is characterized by a diameter 33 and a minimum distance 34 to an adjacent open area. Depending on the diameter 33 and distance 34, different total open area may be obtained as shown in

TABLE 1
The maximum distance between a point in an
open area and the edge of this open area is also
provided (referred to as ‘critical distance to edge’).

| | | | | critical |
|---|---|---|---|---|
| | Diameter 33 | Distance 34 | Total open | distance to |
| type | (mm) | (mm) | area (%) | edge (mm) |
| 1 | 3 | 1.1 | 30 | 1.5 |
| 2 | 4 | 1.5 | 30 | 2 |
| 3 | 5 | 1 | 46 | 2.5 |
| 4 | 6 | 2 | 33 | 3 |
| 5 | 8 | 2 | 40 | 4 |
| 6 | 10 | 3 | 35 | 5 |
| 7 | 12 | 3 | 40 | 6 |
| 8 | 16 | 4 | 40 | 8 |
| 9 | 20 | 5 | 40 | 10 |
| 10 | 24 | 4 | 51 | 12 |
| 11 | 30 | 5 | 51 | 15 |
| 12 | 40 | 8 | 46 | 20 |

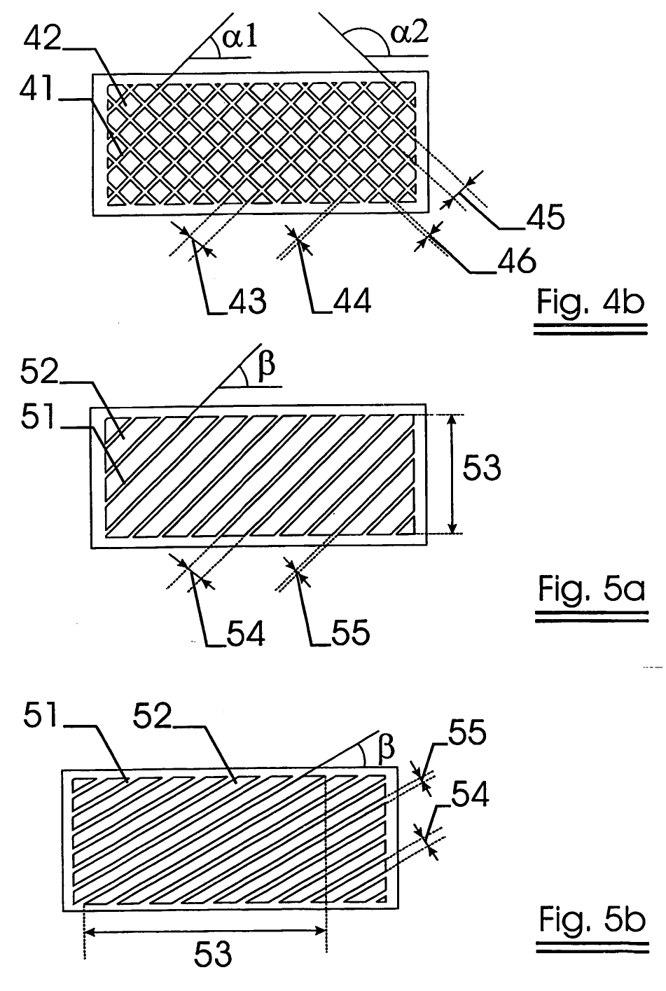

Preferably however, square or rectangular open areas are used, e.g. as shown in FIG. 4a. Also here, a metal area 41 and several repetitive open areas 42 are provided. The dimension of the open areas are determined by the width 43 and height 45, and the distances 44 and 46 to adjacent open areas. Some examples are given in TABLE II. The maximum distance between a point in an open area and the edge of this open area is also provided (referred to as ‘critical distance to edge’).

TABLE II

| | | | | | Total | critical |
|---|---|---|---|---|---|---|
| | | | | | open | distance |
| | Width 43 | Height | Distance | Distance | area | to edge |
| type | (mm) | 45 (mm) | 44 (mm) | 46 (mm) | (%) | (mm) |
| 13 | 15 | 15 | 2 | 2 | 75 | 7.5 |
| 14 | 10 | 10 | 2 | 2 | 70 | 5 |
| 15 | 35 | 35 | 2 | 2 | 90 | 17.5 |

Alternatively, as shown in FIG. 4b, the open areas 42 may be have a diamond-like shape, for which the dimensions are further defined by the angles α1 and α2.

A preferred alternative embodiment when a tubular metal fiber filter element is to be provided, are open areas being parallelogram-like shaped, as shown in FIG. 5a. Also here, a metal area 51 and several repetitive open areas 52 are provided. The dimension of the open areas are determined by the height 53 and width 54, the distances 55 between adjacent open areas, and the inclination angle of the parallelogram β. Some examples are given in TABLE III. The maximum distance between a point in an open area and the edge of this open area is also provided (referred to as ‘critical distance to edge’).

TABLE III

| | | | | | Total | critical |
|---|---|---|---|---|---|---|
| | | | | | open | distance |
| | Height | Width 54 | Distance | Angle β | area | to edge |
| type | 53 (mm) | (mm) | 55 (mm) | (°) | (%) | (mm) |
| 16 | 81 | 16 | 2 | 45 | 85 | 8 |
| 17 | 37 | 37 | 2 | 45 | 90 | 18.5 |

Alternatively, the angle β may be less than 45°, such as 30° as shown in FIG. 5b.

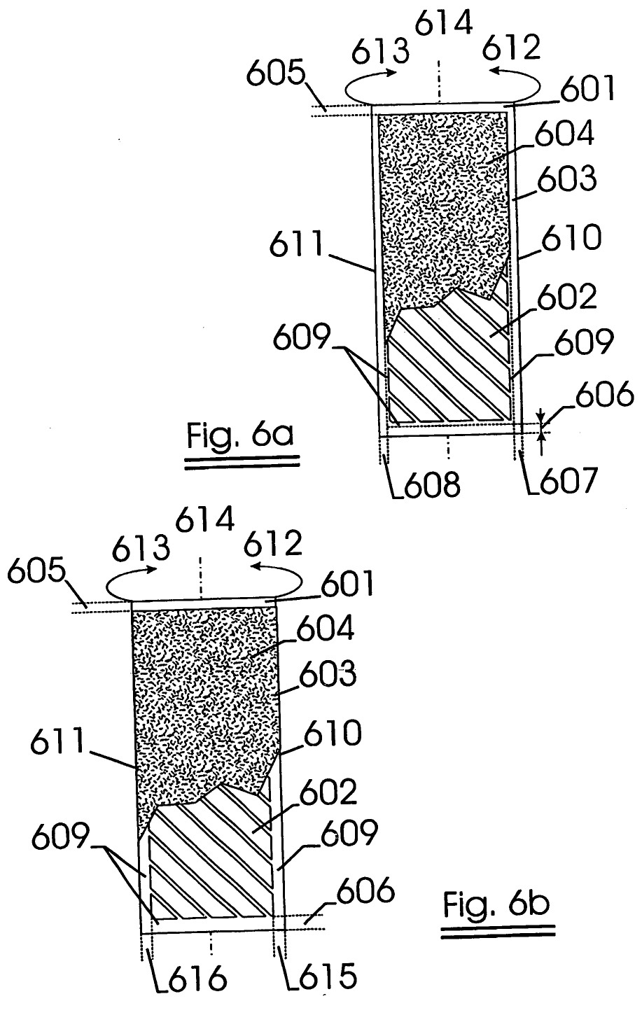

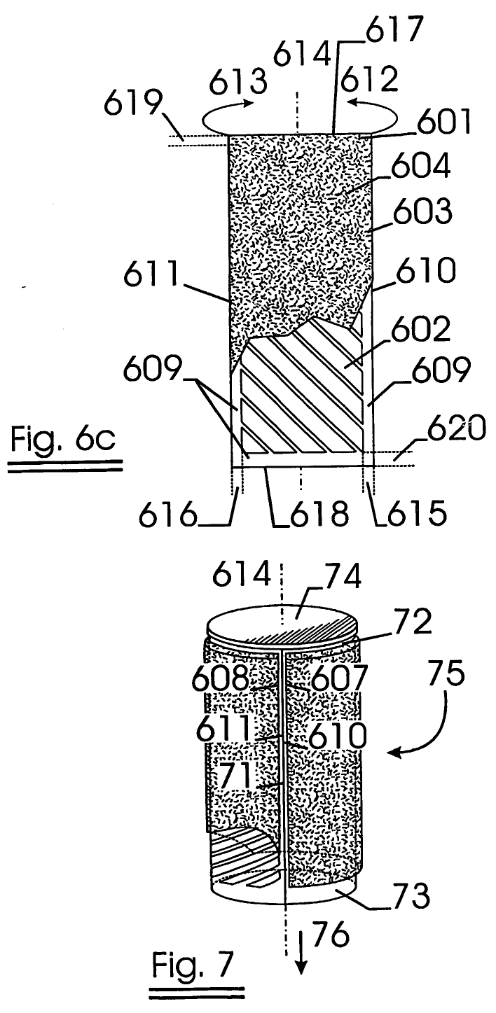

A tubular metal fiber filter element as subject of the invention is shown in FIG. 6a, FIG. 6b, FIG. 6c and FIG. 7. In FIG. 6a, a perforated metal sheet 601, with open parallelogram-like areas 602 and a metal area 603 is sintered to a metal fiber fleece 604, in such a way that all open areas 602 are covered by the metal fiber fleece 604. At the upper and lower side of the perforated metal sheet 601, two parts, 605 and 606, of the perforated metal sheet 601 extend beyond the metal fiber fleece 604. Possibly, at the left and right side, two parts 607 and 608 of the perforated metal sheet extend beyond the metal fiber fleece 604. To avoid non filtered gas or liquid by-passing the edge of the metal fiber fleece 604, a common zone with a width 609 of at least 10 mm is provided. In order to provide a tubular shape to the metal fiber filter element, two edges 610 and 611 are bent to each other, as indicated with arrows 612, respectively 613, around an imaginary axis 614, parallel to the sides 610 and 611. It is clear that the perforated metal sheet is situated at the inner side of the tubular metal fiber filter element and the flow in side of the tubular metal fiber filter element is situated at the outside of the tubular metal fiber filter element.

As shown in FIG. 7, the two edges 610 and 611 are brought together, and are welded over a welding line 71. This may be done by TIG-welding. A tubular shape is provided in this way to the metal fiber filter element. Alternatively, parts 607 and 608 may be positioned in such a way that they partially or fully overlap. They may be welded to each other by resistance welding, providing a welding line 71 as well.

Alternatively, the metal fiber fleece may be present onto the edge 610 and 611 as shown in FIG. 6b. No zone of the metal sheet extends beyond the metal fiber fleece. At both sides of the flat metal fiber filter element, a common zone 615 and 616 is present, with a width of 609. The two edges 610 and 611 are brought together, and are welded over a welding line, similar as shown in FIG. 7. This may be done by TIG-welding. A tubular shape is provided in this way to the metal fiber filter element. Alternatively, parts 615 and 616 may be positioned in such a way that they partially or fully overlap. They may be welded to each other by resistance welding, providing a welding line as well.

Alternatively, the metal fiber fleece may be present onto the edge 617 and 618 as shown in FIG. 6c. No zone of the metal sheet extends beyond the metal fiber fleece. At both sides of the flat metal fiber filter element, a common zone 619 and 620 is present, with a width of 609.

As shown in FIG. 7, at both ends of the tubular metal fiber filter element, two zones 72 and 73 are provided, corresponding to the parts 605 and 606 of the perforated metal sheet, which can be used to connect the metal fiber filter element to other parts of the filter unit. E.g. one zone 72 may be used to receive a cap 74, being welded to the zone 72 in order to close this side of the metal fiber filter element. A metal fiber filter element as subject of the invention as shown in FIG. 7 may then be used to filter, receiving liquid or gas to be filtered at the outer side of the tube as indicated with arrow 75. The filtered liquid or gas is evacuated in axial way as indicated with arrow 76. The particles, being retained at the outer surface of the tube, may be blown or pushed off by using reverse pulses.

However, it was found that when a reverse pulse was given during liquid filtration, a much higher pressure is obtained in the part of the tubular metal fiber filter element close to the end cap 74, as was originally initiated at zone 73 due to the reflection of pressure waves on cap 74.

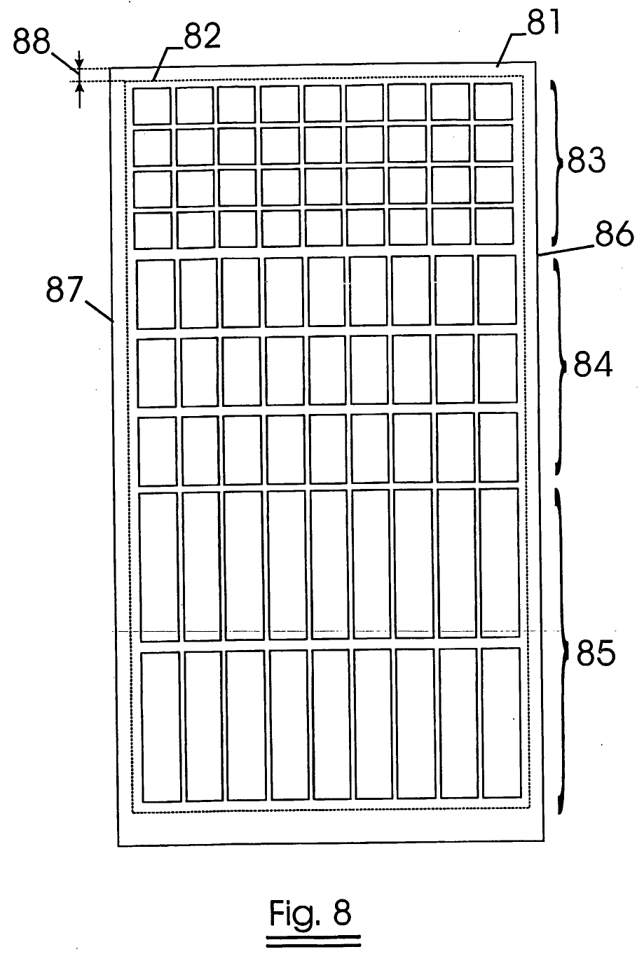

To adapt the reinforcing structure to these different pressures during reverse pulsing, perforated metal sheet with unequal open areas over its surface may be used to provide a tubular metal fiber filter element as subject of the invention. As shown in FIG. 8, a perforated metal sheet 81 is sintered to a metal fiber fleece 82. The perforated metal sheet has e.g. 3 different open areas, a maximum reinforced zone 83, a normal reinforced zone 84 and a minimum reinforced zone 85. In an identical way as described for FIG. 6 and FIG. 7, the edges 86 and 87 are brought to each other providing a tubular shape to the metal fiber filter element, and welded to each other. The metal area zone 88 is used to receive an end cap and the tubular metal fiber filter element is closed at this side by welding the end cap to zone 88. When back pulsing, the higher pressures are compensated by the maximum reinforced zone 83.

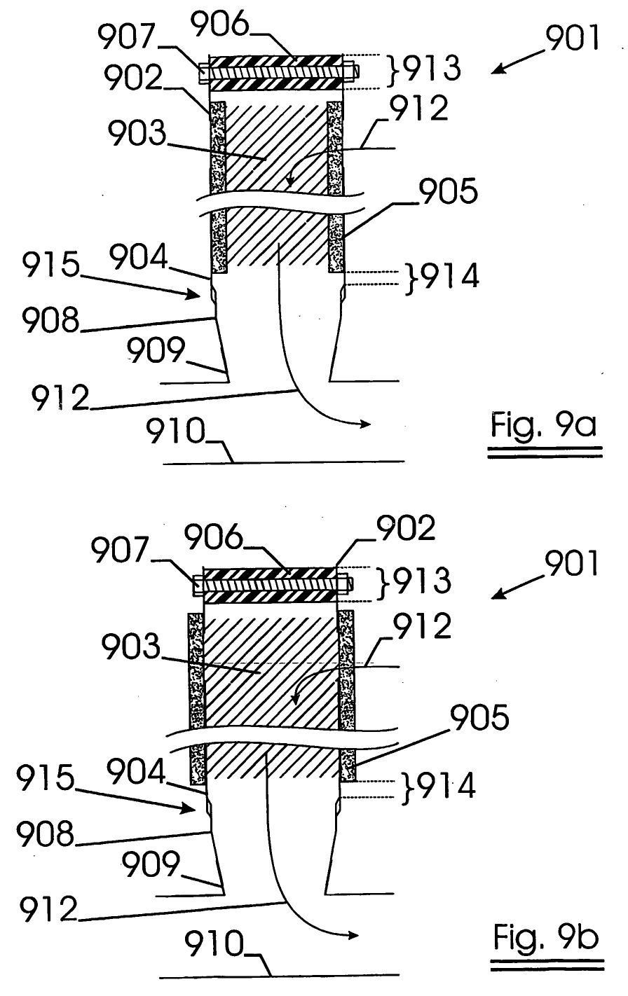

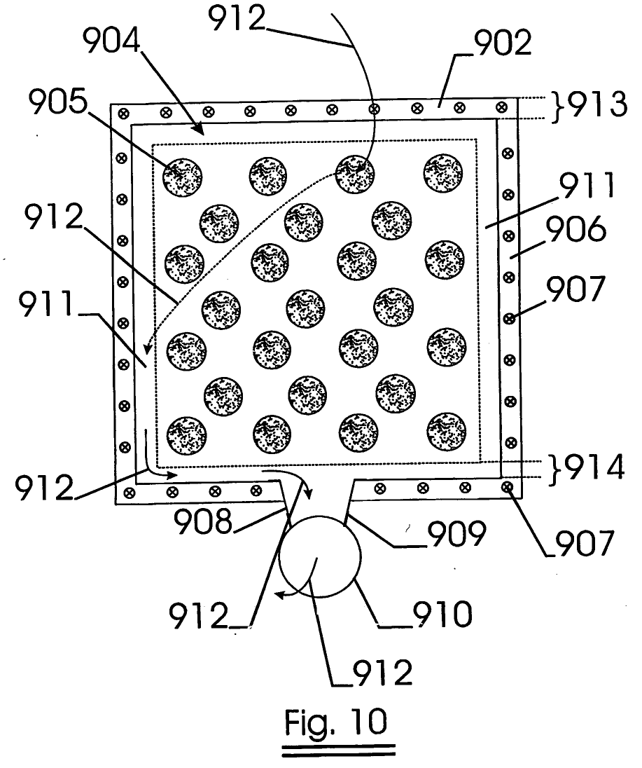

A filter plate 901 as subject of the invention is shown in FIG. 9a, FIG. 9b and FIG. 10. The filter plate 901 comprises two metal fiber filter element 902 and preferably a spacer layer 903, e.g. an expanded metal sheet or woven metal wire mesh. FIG. 9a shows an embodiment having two metal fiber filter element 902, having their reinforcing layer 904 pointing to the outer side of the filter plate 901. The metal fiber fleeces 905 of both metal fiber filter elements 902 are pointing inwards of the filter plate 901. FIG. 9b shows an embodiment having two metal fiber filter elements 902, having their reinforcing layer 904 pointing to the inner side of the filter plate 901. The metal fiber fleeces 905 of both metal fiber filter elements 902 are pointing outwards of the filter plate 901.

At the edge of the filter plate, a sealing means 906 is provided in order to seal the edges of the filter plate, so providing bypasses of unfiltered liquid or gas when the filter plate is used. Both metal fiber filter elements 902 are damped to the sealing means 906, e.g. a polymer strip, e.g. by using a set of bolts and nuts 907, which are located in appropriate openings in both the metal fiber filter elements 902 and sealing means 906.

For the presently shown embodiment, at the lower side of the filter plate 901, an appropriate outlet means 908 is provided, e.g. a conical tubular element. This outlet means 908 may be used to mount the filter plate 901 to a corresponding inlet means 909 of the evacuation duct 910.

Due to the presence of the reinforcing layer 904 of the metal fiber filter element 902, no other support of the filter plate is needed when the filter plate 901 is used in vertical or horizontal position.

Possibly, a wire mesh or other permeable means may be provided at the outer side of the filter plate, in order to prevent mechanical damages to the metal fiber fleece 905, either present at the outer side of the filter plate 901, or present at the outer side at the openings of the reinforcing structure 904.

Also in this case, the presence of parts of the reinforcing layer 904, extending the metal fiber fleece 905 are an advantage for construction reasons. Such zones 913 may be used e.g. to clamp the seal 906, to provide evacuation channels 911 (zone 914), or to fix, e.g. by welding, the outlet means 908 to the metal fiber filter element 902 (zone 915).

Liquids, e.g. wine, beer, olive oil or juice, may be filtered by forcing the liquid to flow from the outer side of the filter plate 901, via the openings in the reinforcing layer 904, via the metal fiber fleece 905, possibly via the spacer layer 903, possibly via evacuation channels 911 into the evacuation duct 910, as indicated with arrows 912.

1. A metal fiber filter element comprising a metal fiber fleece and a reinforcing structure characterized in that said reinforcing structure comprising a metal sheet, said metal sheet having open areas, said metal fiber fleece and metal sheet being sintered to each other, said metal fiber fleece covering said open areas, for all of said open areas, the minimum distance of each point of said open areas, and the edge of said open area being less than 65 mm.

2. A metal fiber filter element as in claim 1, wherein the total open area of said metal sheet is more than 25% of the total surface of said metal fiber fleece, said total open area being the sum of the surfaces of all of said open areas.

3. A metal fiber filter element as in claim 1 or 2, wherein the distance of the edge of said open area closest to the edge of said metal fiber fleece and said edge of said metal fiber fleece is more than 10 mm.

4. A metal fiber filter element as in claim 1 to 3, wherein said edge of said metal fiber fleece is sealed by welding.

5. A metal fiber filter element as in claim 1 to 4, said metal sheet extending beyond said metal fiber fleece.

6. A metal fiber filter element as in claim 1 to 5, said metal fiber fleece and said metal sheet being provided using the same metal alloy.

7. A metal fiber filter element as in claim 1 to 6, said metal fiber fleece comprising metal fibers, said fibers having an equivalent diameter in the range of 0.5 μm to 100 μm.

8. A metal fiber filter element as in claim 1 to 7, said metal fiber filter element has a flow in side and a flow out side, said metal sheet being present at said flow out side.

9. A metal fiber filter element as in claims 1 to 8, said metal fiber filter element comprising two metal fiber fleeces, at each side of said metal sheet one of said metal fiber fleeces is present.

10. A metal fiber filter element as in claim 1 to 9, said metal fiber filter element being a tubular metal fiber filter element.

11. A filter plate, comprising two metal fiber filter elements as in claim 1 to 9, said metal fiber filter elements being parallel to each other, the edges of said filter plate being sealed using a sealing means.

12. A filter plate as in claim 11, said filter plate comprising a spacer layer between said metal fiber filter elements.

13. A method to provide a metal fiber filter element, comprising the steps of
Providing a metal fiber fleece;
Providing a metal sheet comprising open areas wherein for all of said open areas, the minimum distance of each point of said open areas, and the edge of said open area being less than 65 mm;
Sintering said metal sheet and metal fiber fleece to each other.

14. A method to provide a metal fiber filter element as in claim 13, further comprising the steps
Bending sintered metal fiber fleece and metal sheet to a tubular shape;
Sealing the tubular shape by welding, brazing, gluing or soldering;

15. A method to provide a metal fiber filter element as in claim 13 or 14, comprising the step of sintering said metal fiber fleece before sintering said metal fiber fleece and said metal sheet.

16. A method to provide a metal fiber filter element as in claim 13 to 15, wherein the total open area of said metal sheet is more than 25% of the total surface of said metal fiber fleece, said total open area being the sum of the surfaces of all of said open areas.

17. A method to provide a metal fiber filter element as in claim 13 to 16, wherein the distance of the edge of said open area closest to the edge of said metal fiber fleece and edge of said metal fiber fleece is more than 10 mm.

18. The use of a metal fiber filter element as in claim 1 to 10 as a filter element in reverse pulsing filtration operation.

19. The use of a metal fiber filter element as in claim 18, said reverse pulses are applied at flow out side of said filter element, said metal sheet is present at said outflow side.

20. The use of a metal fiber filter element as in claim 1 to 10 for filtering food liquids.

21. The use of a metal fiber filter element as in claim 1 to 10, for filtering cooling liquids.

22. The use of a metal fiber filter element as in claim 1 to 10, for filtering waste waters.

23. The use of a filter plate as in claim 11 or 12 for filtering food liquids.

24. The use of a filter plate as in claim 11 or 12, for filtering cooling liquids.

25. The use of a filter plate as in claim 11 or 12, for filtering waste waters.

26. The use of a metal fiber filter element obtainable according to a method of claim 13 to 17 for filtering food liquids.

27. The use of a metal fiber filter element obtainable according to a method of claim 13 to 17 for filtering cooling liquids.

28. The use of a metal fiber filter element obtainable according to a method of claim 13 to 17 for filtering waste waters.
